(19) United States
(12) Patent Application Publication
(10) Pub. No.: US 2005/0120331 A1
(43) Pub. Date: Jun. 2, 2005

(54) Hosting environment abstraction agents

(75) Inventors: Kwasi Addo Asare, Durham, NC (US); Attila Barta, Toronto (CA); Richard D. Huddleston, Newtonville, MA (US); Daniel E. Jemiolo, Pascoag, RI (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/726,192

(22) Filed: Dec. 2, 2003

(51) Int. Cl. G06F 9/44

(52) U.S. Cl. 717/104; 717/120

(57) ABSTRACT

The present invention is a method, system and apparatus for hosting environment abstraction. A method for hosting environment abstraction can include the step of enumerating each of a set of components in an application and identifying dependencies between each component in the set. A generic representation of the set of components can be organized into a hierarchical structure based upon the identified dependencies. Consequently, a model encapsulating the hierarchical structure can be produced. Optionally, dependencies between target platform resources and the components in the set further can be identified and recorded in the model. Finally, the model can be stored in a repository for subsequent retrieval.

### BACKGROUND OF THE INVENTION

1. Statement of the Technical Field

The present invention relates to the field of application component distribution, and more particularly to the target platform neutral management of application component requirements during the installation of an application component.

2. Description of the Related Art

Though often overlooked, application installation is a prerequisite to interacting with a software application. Specifically, in most circumstances, an application can be properly executed only subsequent to the completion of a successful installation process. At the minimum, a typical software application installation requires a transfer of files to the file structure of a computing system, and the configuration of the computing system to particularly interact with the software application. Ordinarily, the configuration of the computing system includes the addition or modification of registry settings, the addition or modification of entries to one or more initialization files, or both.

In the context of an application installation meant to upgrade the components of an application, oftentimes, simply replacing application out-dated versions of application components with newer versions of components will not alone suffice as a complete application upgrade. Rather, in an era of code re-use, shared libraries, and interdependent program objects, replacing a single application component can have a dramatic effect upon other separate, but independent applications. Common disastrous consequences include altered and now incompatible application programming interfaces (APIs), re-positioned application objects, and removed application objects. In all cases, an application dependency can be broken simply by upgrading the application components of another, unrelated application.

Whereas application component upgrades can be problematic generally, in an autonomic system, the problem can be particularly acute. For the uninitiated, autonomic computing systems self-regulate, self-repair and respond to changing conditions, without requiring any conscious effort on the part of the computing system operator. To that end, the computing system itself can bear the responsibility of coping with its own complexity. The crux of autonomic computing relates to eight principal characteristics:

I. The system must “know itself” and include those system components which also possess a system identify.

II. The system must be able to configure and reconfigure itself under varying and unpredictable conditions.

III. The system must never settle for the status quo and the system must always look for ways to optimize its workings.

IV. The system must be self-healing and capable of recovering from routine and extraordinary events that might cause some of its parts to malfunction.

V. The system must be an expert in self-protection.

VI. The system must know its environment and the context surrounding its activity, and act accordingly.

VII. The system must adhere to open standards.

VIII. The system must anticipate the optimized resources needed while keeping its complexity hidden from the user.

Thus, in keeping with the principles of autonomic computing, the installation of application components must not only account for the seamless installation and configuration of the application components, but also the impact of the installation upon existing applications in the target platform. Moreover, it can be important that dependencies required for the nominal operation of the application components exist within the target platform, or can be accessed from the target platform. Finally, it can be critical that the infrastructure provided by the target platform, including its computing resources, meets the resource requirements of the application components. Hence, it will be of paramount concern to the autonomic system that the target platform itself will not become “broken” in consequence of the installation of the application components.

Presently, several application upgrade strategies exist. One such well-known strategy includes the venerable “ReadMe” file. In this strategy, software developers provide a list, typically as standard prose, of components in the application which are to be installed, the required pre-requisite components and any resource requirements to be provided by the target platform. Subsequently, during installation, an application administrator can peruse the contents of the list to determine the nature of the component installation. As it will be recognized by one skilled in the art, however, the creation and use of a conventional ReadMe file can be both tedious and unreliable. Moreover, the ReadMe file mostly can relate specifically to the target platform and the resources provided therein.

Recent trends in enterprise computing have given rise to the component based application consisting of a collection of independent, but interoperable components which in combination can achieve the functionality of a complete application. The components typically can be instantiated within a component hosting environment which itself can execute within an operating system. To install new functionality into a component based application, the installation can require the augmentation of the collection with additional components. Like installing a conventional application in a target specific host environment, when installing a new component in a component based application, dependencies and conflicts between components must be respected and a clean, un-installation path must be maintained to accommodate the circumstance of a failed installation.

Yet, unlike the case of a conventional application installation where the target specific platform and its resources can be precisely defined, in the component based application paradigm, the collection of components typically can be poorly defined and can be uninformative in nature. Thus, the existing structure for component classification can break down at the operating system level. The limited knowledge of application components of other components in the application can be combined with the non-existent knowledge of application component dependencies to produce a completely ineffective platform for component installation. As a result of this unstructured format, component installations can be error prone and tedious.

### SUMMARY OF THE INVENTION

The present invention addresses the deficiencies of the art in respect to application component distribution and provides a novel and non-obvious method, system and apparatus for hosting environment abstraction. A method for hosting environment abstraction can include the step of enumerating each of a set of components in an application and identifying dependencies between each component in the set. A generic representation of the set of components can be organized into a hierarchical structure based upon the identified dependencies. Consequently, a model encapsulating the hierarchical structure can be produced. Optionally, dependencies between target platform resources and the components in the set further can be identified and recorded in the model. Finally, the model can be stored in a repository for subsequent retrieval.

The identifying step can include the step of inspecting each component in the set for data and method member references to other ones of the components in the set. In particular, the references can indicate a dependency. Similarly, the step of further identifying dependencies between target platform resources and the components in the set can include the step of inspecting each component in the set for data and method member references to the target platform resources. In either case, the producing step can include the step of writing the hierarchical structure to a markup language document wherein tags in the markup language document demarcate individual ones of the components and the identified dependencies.

Each of the steps of enumerating, identifying, organizing, producing and storing step can be performed subsequent to installing the application in a target platform. Moreover, the model can be retrieved from the repository prior to installing a new component for use in the application. In either case, a hosting environment abstraction system can be configured to perform the foregoing inventive method. In this regard, a hosting environment abstraction system can include a hosting environment configured to support an application having one or more interdependent components and resources which support at least one of the interdependent components. The system further can include a repository configured to store a dependency model of the application. Finally, the system can include a classification processor coupled to the hosting environment and the repository.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system for abstracting a hosting environment;

FIG. 2 is a pictorial illustration of an exemplary abstraction process performed in the system of FIG. 1; and,

FIG. 3 is a flow chart illustrating a process for abstracting a hosting environment in accordance with the inventive arrangements.

### DETAILED DESCRIPTION OF THE PREFERRED EMBODIMENTS

The present invention is a method, system and apparatus for abstracting a hosting environment to facilitate component installation to target hosting environments, regardless of the specific configuration of the target hosting environment. In accordance with the present invention, each component in an application can be classified according to dependencies which can be identified in each component. Specifically, a hierarchical view of the components can be generated to reflect both inter-component dependencies and also dependencies between components and underlying hosting environment resources.

The hierarchical view can be persisted in a repository and recalled subsequently during an installation process so that the requirements and impact of the installation of an application component can be evaluated in respect to the configuration of the application as described by the hierarchy. In particular, using the hierarchical view, underlying resources required by and utilized by the application can be determined. Moreover, the dependencies between different components in the application can be identified. In this way, the impact of adding a new component to the application can be assessed in terms of whether required components already exist in the application and whether required resources in the target platform further exist for the benefit of the new component.

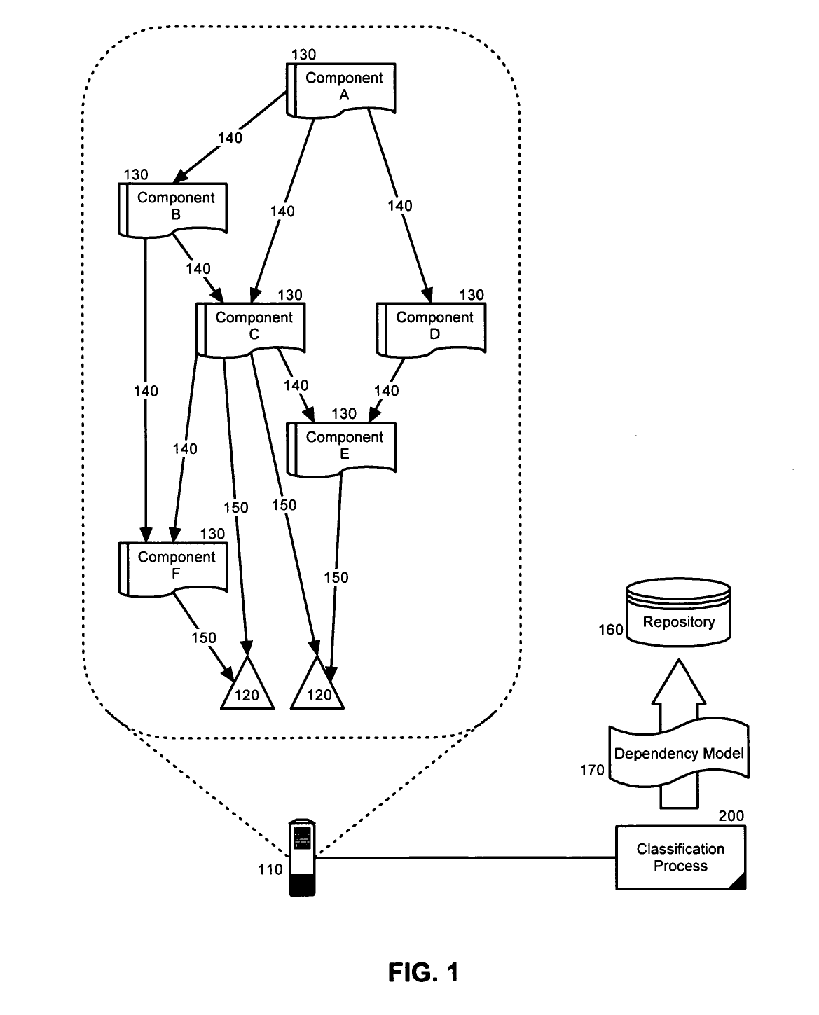

In further illustration of the foregoing invention, FIG. 1 is a schematic illustration of a system for abstracting a hosting environment. The system can include a host environment 110 such as an operating system, a virtual machine operating within the operating system, or an application server executing within the operating system. The host environment 110 can include one or more environmental resources 120, for instance disk space, memory, communications bandwidth and the like. An application consisting of a collection of interoperable component instances 130 can be disposed within the host environment and can utilize the environmental resources 120. Notably, the component instances 130 can be inter-related through known dependent links 140. Practically speaking, the dependent links 140 can take the form of references to one another in data members of the component instances 130, and calls to methods disposed within other ones of the component instances 130.

The inter-relationships between the different component instances 130 can be classified within the classification process 200 which can be disposed within the host environment 110, or which can be disposed externally to the host environment 110, but which can remain communicatively coupled to the host environment 110. In any case, the classification process 200 can produce a hierarchical representation of the component instances 130 and the environmental resources 120. Moreover, the classification process 200 can record the nature of the dependent links 140 between the component instances 130 and the environmental resources 120. Both can be recorded in a dependency model 170 of the application, for example within an XML formatted document. Subsequently, the dependency model 170 can be stored to the repository 160.

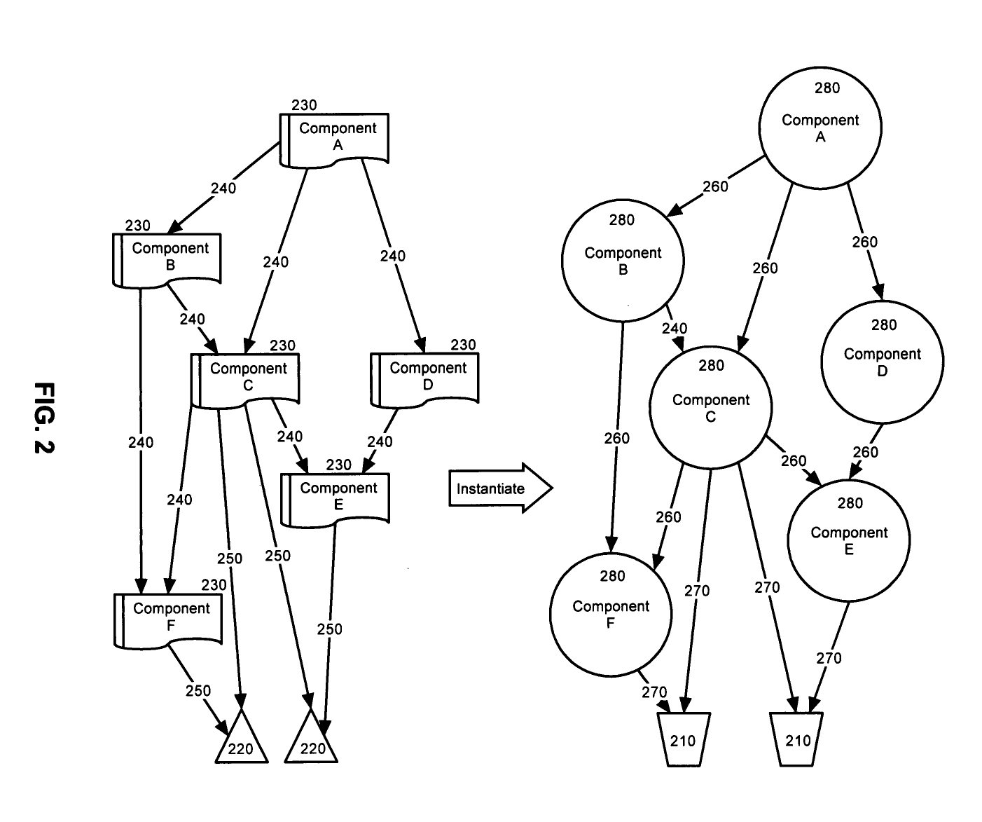

FIG. 2 is a pictorial illustration of an exemplary abstraction process performed in the system of FIG. 1. In the exemplary abstraction process, an application comprised of a selection of application components can be modeled hierarchically in a portable document such as a markup language document. In particular, at the time of installation of the application in a target platform, the process can be performed to produce an abstract representation of the installation in a markup language document. More particularly, the markup language document can specify the hierarchical structure of the application, the interdependencies 240 of the application components 230 in the application and the resource dependencies 250 associated with generic resources 220 for a host platform.

The application components 230 can be representative of an atomic portion of an application which can be physically separated from the remaining portions of the application. In this regard, the application components 230 can be compiled objects, libraries, beans, class files and the like. The interdependencies 240 can be representative of dependent relationships between each of the application components 230. These interdependencies 240 can be resolved by inspecting method calls to methods disposed within different ones of the components 230 thus indicating a dependent relationship. Similarly, the interdependencies 240 can be resolved by inspecting data references to other components 230.

Based upon the model of the hierarchical structure, an actual application instance can be deployed in a target platform having specific computing resources 210. As shown in FIG. 2, the components 230 in the model can be mapped to actual instances 280 of the components 230 in the target platform. Though the actual instances 280 can vary from target platform to target platform, the interdependencies 240 described in the model can translate directly to actual interdependencies 260, 270 reflected in the target platform. In this regard, when deploying an instance of the application in a target platform, it can be ensured that all required dependencies pre-exist in the target platform, or that all required dependencies can be acquired readily in the target platform.

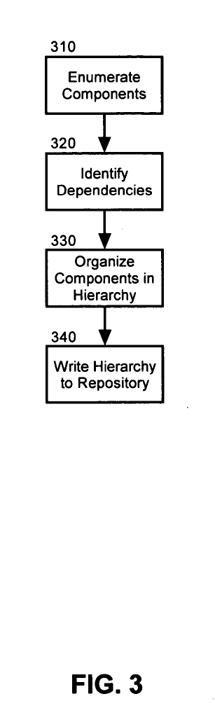

To produce the hierarchical model, a method for abstracting an application from an application instance in a specific target platform to a genericized representation can be provided. The method can be performed in a stand-alone tool, as part of an installation process, or in conjunction with an integrated development environment. In this regard, FIG. 3 is a flow chart illustrating a process for abstracting a hosting environment in accordance with the inventive arrangements. Beginning in block 310, all components in the application can be enumerated. Subsequently, in block 320 the interdependencies between the components can be identified. Preferably, the interdependencies can be identified by inspecting data and method members of each component.

In block 330, the components can be representatively organized in a hierarchy which can be written to a markup language document able to be processed during an installation process. Finally, in block 340 the document can be stored in a repository 340 which can be accessed during the installation process. The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A hosting environment abstraction method comprising the steps of:
enumerating each of a set of components in an application;
identifying dependencies between each component in said set;
organizing a generic representation of said set of components into a hierarchical structure based upon said identified dependencies;
producing a model encapsulating said hierarchical structure; and,
storing said model in a repository for subsequent retrieval.

2. The method of claim 1, further comprising the steps of:
further identifying dependencies between target platform resources and said components in said set; and,
recording said further identified dependencies in said model.

3. The method of claim 1, wherein said identifying step comprises the step of inspecting each component in said set for data and method member references to other ones of said components in said set, said references indicating a dependency.

4. The method of claim 2, wherein said further identifying step comprises the step of inspecting each component in said set for data and method member references to said target platform resources.

5. The method of claim 1, wherein said producing step comprises the step of writing said hierarchical structure to a markup language document wherein tags in said markup language document demarcate individual ones of said components and said identified dependencies.

6. The method of claim 1, further comprising the step of performing enumerating, identifying, organizing, producing and storing step subsequent to installing said application in a target platform.

7. The method of claim 1, further comprising the step of retrieving said model from said repository prior to installing a new component for use in said application.

8. A hosting environment abstraction system comprising:
a hosting environment configured to support an application comprising a plurality of interdependent components and resources which support at least one of said interdependent components;
a repository configured to store a dependency model of said application; and,
a classification processor coupled to said hosting environment and said repository.

9. The system of claim 8, wherein said hosting environment comprises one of an operating system, an application server and a virtual machine.

10. The system of claim 8, wherein said dependency model comprises an XML formatted document.

11. A machine readable storage having stored thereon a computer program for hosting environment abstraction, the computer program comprising a routine set of instructions which when executed by the machine cause the machine to perform the steps of:
enumerating each of a set of components in an application;
identifying dependencies between each component in said set;
organizing a generic representation of said set of components into a hierarchical structure based upon said identified dependencies;
producing a model encapsulating said hierarchical structure; and,
storing said model in a repository for subsequent retrieval.

12. The machine readable storage of claim 11, further comprising the steps of:
further identifying dependencies between target platform resources and said components in said set; and,
recording said further identified dependencies in said model.

13. The machine readable storage of claim 11, wherein said identifying step comprises the step of inspecting each component in said set for data and method member references to other ones of said components in said set., said references indicating a dependency.

14. The machine readable storage of claim 12, wherein said further identifying step comprises the step of inspecting each component in said set for data and method member references to said target platform resources.

15. The machine readable storage of claim 11, wherein said producing step comprises the step of writing said hierarchical structure to a markup language document wherein tags in said markup language document demarcate individual ones of said components and said identified dependencies.

16. The machine readable storage of claim 11, further comprising the step of performing enumerating, identifying, organizing, producing and storing step subsequent to installing said application in a target platform.

17. The machine readable storage of claim 11, further comprising the step of retrieving said model from said repository prior to installing a new component for use in said application.
